(19) United States
(12) Patent Application Publication
(10) Pub. No.: US 2006/0212853 A1
(43) Pub. Date: Sep. 21, 2006

(54) Real-time control apparatus having a multi-thread processor

(75) Inventor: Sehat Sutardja, Los Altos, CA (US)

Correspondence Address: FISH & RICHARDSON P.C., P.O BOX 1022, MINNEAPOLIS, MN, 55440-1022, US

(73) Assignee: Marvell World Trade Ltd., Hamilton (BM)

(21) Appl. No.: 11/084,386

(22) Filed: Mar. 18, 2005

(51) Int. Cl. G06F 9/44

(52) U.S. Cl. 717/131

(57) ABSTRACT

In one implementation, a real-time controller is provided. The real-time controller includes a multi-thread processor adapted to execute at least two threads of program code. The multi-thread processor includes an execution pipeline, and a thread control unit to control the execution pipeline to execute media processing related program code as a first thread and system level program code as a second thread.

### CROSS-REFERENCE TO RELATED APPLICATIONS

The present application is a continuation in part of commonly owned U.S. patent application entitled—“Dual Thread Processor” by Hong-Yi Chen and Sehat Sutardja, attorney docket no. MP0633/13361-142001, filed concurrently herewith, the entire contents of which are incorporated by reference in their entirety.

### BACKGROUND

The following disclosure relates to processing circuits and systems.

Conventional operating systems typically support multitasking, which is a scheduling scheme that permits more than one processor thread to share common processing resources. A processor thread represents an architectural state within a processor that tracks execution of a software program. In the case of a computer having a single processor, only one processor thread is processed at any given point in time, meaning that the processor is actively executing instructions associated with a single processor thread. The act of re-assigning a processor from one processor thread to another is called a context switch.

In a conventional pipeline processor, a context switch typically occurs through a hardware interrupt and interrupt service routine. Interrupt service routines typically have an associated execution time, or interrupt overhead, that may consume valuable processor time. Additionally, in a conventional pipeline processor, a context switch typically occurs only at fixed intervals (e.g., every 100 μs), as determined by, e.g., vendors of an operating system.

### SUMMARY

In general, in one aspect, this specification describes a hard disk controller including a multi-thread processor adapted to execute at least two threads of program code. The multi-thread processor includes an execution pipeline, and a thread control unit to control the execution pipeline to execute servo related program code as a first thread and system level program code as a second thread.

Particular implementations can include one or more of the following. The hard disk controller can further include a memory to store the servo related program code and the system level program code. The memory can store user provided program code. The thread control unit can control the execution pipeline to execute the user provided program code as a third thread. The execution pipeline can include an instruction fetch unit, a decoder responsive to the instruction fetch unit, an issue unit responsive to the decoder, and an execution unit responsive to the issue unit. The system level program code can include at least one of disk drive data capture program code, error correction program code, host protocol management program code, cache management program code, or defect manager program code. The host protocol management program code can manage at least one of the following protocols ATA, USB, SATA, SAS, FC, CE-ATA, SDIO. The hard disk controller can further include a second multi-thread processor adapted to execute at least two threads of program code. The second multi-thread processor can include a second execution pipeline, and a second thread control unit to control the second execution pipeline to execute first real-time program code as a third thread and second real-time program code as a fourth thread. The second multi-thread processor can execute a given thread of program code not executed by the first multi-thread processor. The hard disk controller can further include a read channel.

In general, in another aspect, this specification describes a DVD controller including a multi-thread processor adapted to execute at least two threads of program code. The multi-thread processor includes an execution pipeline, and a thread control unit to control the execution pipeline to execute servo related program code as a first thread and system level program code as a second thread.

In general, in another aspect, this specification describes a media player device including a multi-thread processor adapted to execute at least two threads of program code. The multi-thread processor includes an execution pipeline, and a thread control unit to control the execution pipeline to execute media processing related program code as a first thread and system level program code as a second thread.

In general, in another aspect, this specification describes a cellular WLAN system including a multi-thread processor adapted to execute at least two threads of program code. The multi-thread processor includes an execution pipeline, and a thread control unit to control the execution pipeline to execute cellular communication related program code as a first thread and system level program code as a second thread.

Particular implementations can include one or more of the following features. The cellular communication related program code can relate to one or more of the following protocols CDMA, G3, GSM, or the like. The system level program code can include at least one of menu program code, display program code, MAC program code, WLAN program code, network communication program code, error correction program code, video processing program code, audio processing program code, host protocol management program code, cache management program code, defect manager program code, encryption/decryption program code, compression/decompression program code, wireless/wired communication program code or security management program code.

In general, in another aspect, this specification describes a VoIP system including a multi-thread processor adapted to execute at least two threads of program code. The multi-thread processor includes an execution pipeline, and a thread control unit to control the execution pipeline to execute voice processing related program code as a first thread and system level program code as a second thread.

Particular implementations can include one or more of the following features. The thread control unit can further control the execution pipeline to execute codec related program code as a third thread. The voice processing related program code can be program code associated with processing voice signals for conversion to a suitable form for transmission over a network. The system level program code can include at least one of MAC program code, WLAN program code, network communication program code, error correction program code, video processing program code, audio processing program code, host protocol management program code, cache management program code, defect manager program code, encryption/decryption program code, compression/decompression program code, wireless/wired communication program code or security management program code.

In general, in another aspect, this specification describes a wireless network device system including a multi-thread processor adapted to execute at least two threads of program code. The multi-thread processor includes an execution pipeline, and a thread control unit to control the execution pipeline to execute wireless network related program code as a first thread and system level program code as a second thread.

Particular implementations can include one or more of the following features. The wireless network related program code can include at least one of routing program code, network program code, access point program code, repeater program code, security program code, virtual private network program code or program code implementing a wireless communication protocol. The system level program code can include at least one of MAC program code, WLAN program code, network communication program code, error correction program code, video processing program code, audio processing program code, host protocol management program code, cache management program code, defect manager program code, encryption/decryption program code, compression/decompression program code, wired communication program code or security management program code.

In general, in another aspect, this specification describes a wireless television system including a multi-thread processor adapted to execute at least two threads of program code. The multi-thread processor includes an execution pipeline, and a thread control unit to control the execution pipeline to execute media related program code as a first thread and system level program code as a second thread.

Particular implementations can include one or more of the following features. The media related program code can include at least one of video processing program code or audio processing program code. The system level program code can include at least one of MAC program code, WLAN program code, network communication program code, error correction program code, video processing program code, audio processing program code, host protocol management program code, cache management program code, defect manager program code, encryption/decryption program code, compression/decompression program code, wired/wireless communication program code or security management program code.

In general, in another aspect, this specification describes a broadband modem including a multi-thread processor adapted to execute at least two threads of program code. The multi-thread processor includes an execution pipeline, and a thread control unit to control the execution pipeline to execute broadband communication related program code as a first thread and system level program code as a second thread.

Particular implementations can include one or more of the following. The broadband communication related program code includes cable communication program code, DSL communication code, or satellite communication program code. The system related code can include at least one of MAC program code, WLAN program code, network communication program code, error correction program code, video processing program code, audio processing program code, host protocol management program code, cache management program code, defect manager program code, encryption/decryption program code, compression/decompression program code, wired/wireless communication program code or security management program code.

In general, in another aspect, this specification describes a wired router including a multi-thread processor adapted to execute at least two threads of program code. The multi-thread processor includes an execution pipeline, and a thread control unit to control the execution pipeline to execute networking related program code as a first thread and system level program code as a second thread.

Particular implementations can include one or more of the following features. The networking related program code can include at least one of routing program code, access point program code, security program code, repeater program code, virtual private networking program code or program code implementing a communication protocol. The system level program code can include at least one of MAC program code, WLAN program code, network communication program code, error correction program code, video processing program code, audio processing program code, host protocol management program code, cache management program code, defect manager program code, encryption/decryption program code, compression/decompression program code, wireless communication program code or security management program code.

In general, in another aspect, this specification describes a real-time controller including a multi-thread processor adapted to execute at least two threads of program code. The multi-thread processor includes an execution pipeline, and a thread control unit to control the execution pipeline to execute media related program code as a first thread and system level program code as a second thread.

In general, in another aspect, this specification describes a method that includes providing a first real-time program code; providing a second real-time program code; executing the first real-time program code with a first processor thread though an execution pipeline of a multi-thread processor; and executing the second real-time program code with a second processor thread though the execution pipeline of the multi-thread processor.

In general, in another aspect, this specification describes a real-time controller. The real-time controller includes means for executing at least two threads of program code. The means for executing includes execution pipeline means, and means for controlling the execution pipeline means to execute first real-time program code as a first thread and second real-time program code as a second thread.

Particular implementations can include one or more of the following features. The real-time controller can include means for storing the first real-time program code and the second real-time program code. The means for storing can further store user provided program code. The means for controlling can control the execution pipeline means to execute the user provided program code as a third thread. The execution pipeline means can include means for fetching an instruction, means for decoding a fetched instruction, means for issuing a decoded instruction, and means for executing an issued instruction. The real-time controller can further include a second means for executing at least two threads of program code. The second means for executing includes a second execution pipeline means, and means for controlling the second execution pipeline means to execute third real-time program code as a third thread and fourth real-time program code as a fourth thread.

In general, in another aspect, this specification describes a real-time controller including means for providing a first real-time program code; means for providing a second real-time program code; means for executing the first real-time program code with a first processor thread though an execution pipeline of a multi-thread processor; and means for executing the second real-time program code with a second processor thread though the execution pipeline of the multi-thread processor.

Particular implementations can include one or more of the following. The first real time code can be video processing program code and the second real time code can be audio program code.

Implementations can include one or more of the following advantages. Applications including a single multi-thread processor are included that do not require multi-processor (e.g., CPU-to-CPU) management. Consequently, processor time associated with multi-processor management is eliminated. Reduction in the number of CPUs within an application further reduces manufacturing costs associated with a given application. Further, a multi-thread processor guarantees that computing resources are available for a given program code through an available processor thread that can be dedicated to the program code. A multi-thread processor also allows for independent development of software codes to be executed by the multi-thread processor.

The details of one or more implementations are set forth in the accompanying drawings and the description below. Other features and advantages will be apparent from the description and drawings, and from the claims.

### DESCRIPTION OF DRAWINGS

FIG. 1 is a block diagram of a multi-thread pipeline processor architecture.

FIG. 2 is method of operation for a multi-thread processor configured in accordance with the multi-thread pipeline processor architecture of FIG. 1.

FIG. 3 is a block diagram of a multi-thread pipeline processor in accordance with the multi-thread pipeline processor architecture of FIG. 1.

FIG. 4 is a block diagram of a multi-thread pipeline processor architecture.

FIG. 5 is a block diagram of a multi-thread pipeline processor in accordance with the multi-thread pipeline processor architecture of FIG. 4.

FIG. 6 is a method of performing exception handling in the multi-thread pipeline processor architectures of FIGS. 1 and 4.

FIG. 7 is a method of performing interrupt handling in the multi-thread pipeline processor architectures of FIGS. 1 and 4.

FIG. 8 is a functional block diagram of a hard disk drive system including a multi-thread processor.

FIG. 9 is a functional block diagram of a digital versatile disc (DVD) system including a multi-thread processor.

FIG. 10 is a functional block diagram of cellular WLAN (Wireless Local Area Network) system including a multi-thread processor.

FIG. 11 is a functional block diagram of a VoIP system including a multi-thread processor.

FIG. 12 is a functional block diagram of a wireless network device including a multi-thread processor.

FIG. 13 is a functional block diagram of a wireless television system including a multi-thread processor.

FIG. 14 is a functional block diagram of a broadband modem including a multi-thread processor.

FIG. 15 is a functional block diagram of a wired router including a multi-thread processor.

FIG. 16 is a functional block diagram of a wireless media player including a multi-thread processor.

FIG. 17 is a functional block diagram of a real-time controller including a multi-thread processor.

Like reference symbols in the various drawings indicate like elements.

### DETAILED DESCRIPTION

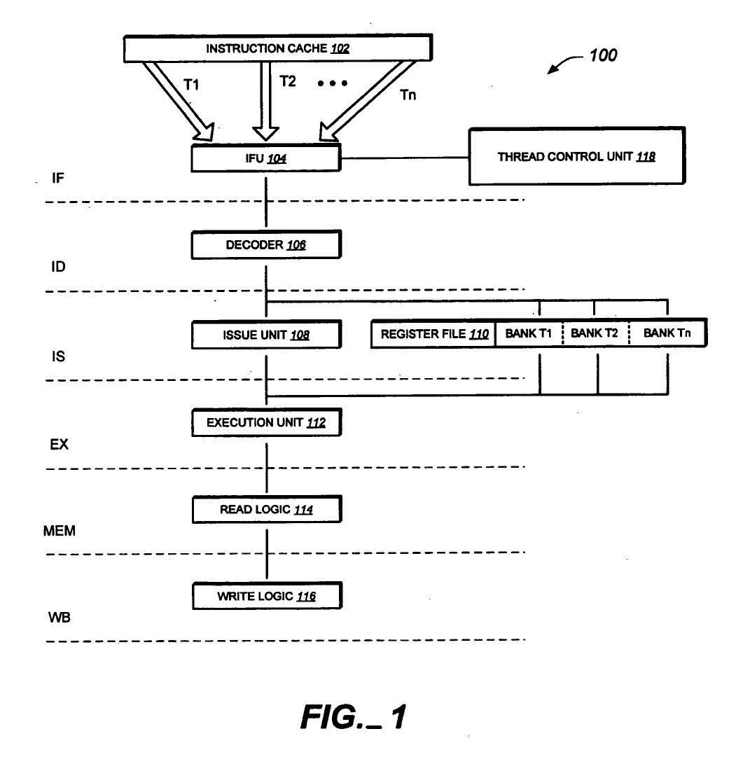

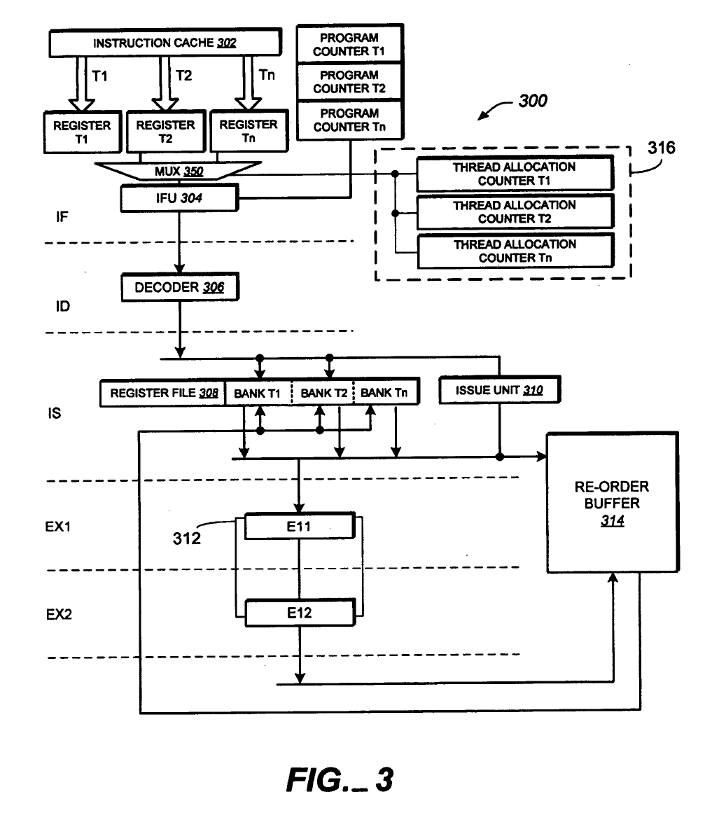

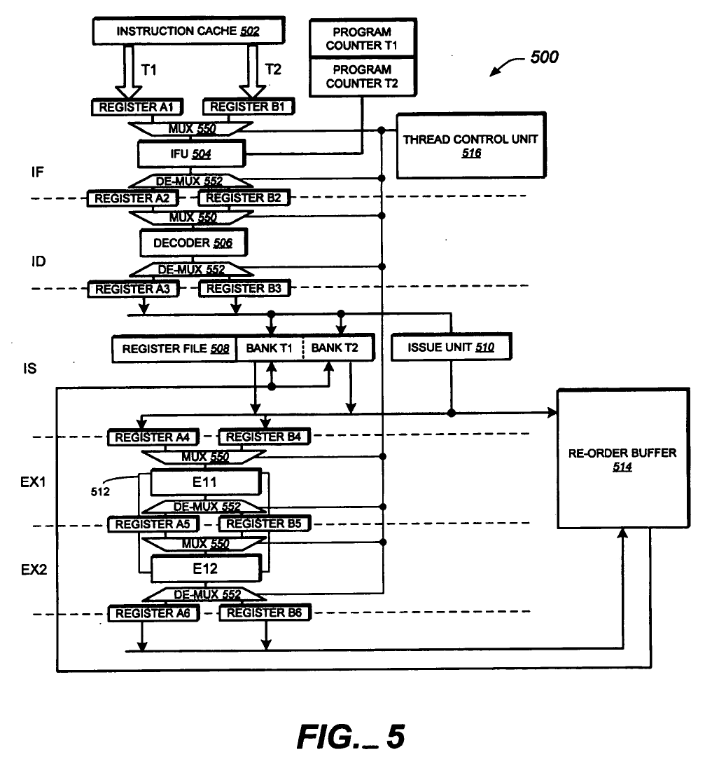

FIG. 1 is a block diagram of a multi-thread pipeline processor architecture 100 that is operable to process two or more processor threads T1, T2, . . . Tn. Processor threads T1, T2, . . . Tn each represent an architectural state within multi-thread pipeline processor architecture 100 that tracks execution of corresponding software programs. Instructions for the software programs can be retrieved from, for example, an instruction cache (e.g., instruction cache 102). In one implementation, multi-thread pipeline processor architecture 100 includes two or more program counters (not shown) each of which corresponds to a processor thread T1, T2, . . . Tn. Each program counter indicates where (for a corresponding processor thread T1, T2, . . . Tn) multi-thread pipeline processor architecture 100 is with respect to an instruction sequence. Program counters are discussed in greater detail below in association with FIGS. 3 and 5.

In one implementation, multi-thread pipeline processor architecture 100 includes six pipeline stages. The six pipeline stages include an instruction fetch stage (IF), an instruction decode stage (ID), an instruction issue stage (IS), an instruction execution stage (EX), a data memory read stage (MEM), and write back stage (WB). Multi-thread pipeline processor architecture 100, however, can include a different number of pipeline stages. Multi-thread pipeline processor architecture 100 further includes an instruction fetch unit (IFU) 104, a decoder 106, issue unit 108, a register file 110, an execution unit 112, read logic 114, write logic 116, and a programmable thread allocation controller (or thread control unit) 118.

Instruction fetch unit 104 retrieves program instructions from, e.g., instruction cache 102. Decoder 106 decodes the program instructions and generates decoded instructions to be executed by execution unit 112. In one implementation, the decoded instructions are fixed length micro-op instructions. Issue unit 108 issues decoded instructions to execution unit 112 for execution. Execution unit 112 can be a load execution unit, store execution unit, arithmetic logic unit (ALU), multiply and accumulate (MAC) unit, or a composite load/store execution unit as described in U.S. patent application entitled—“Variable Length Pipeline Processor Architecture” by Hong-Yi Chen and Jensen Tjeng, attorney docket no. MP0634/13361-140001, which is incorporated by reference in its entirety. Read logic 114 reads data from, e.g., a data cache (not shown). Write logic 116 writes results of executed instructions back to, e.g., a data cache, register file 110, or a re-order buffer (not shown).

Register file 110 stores data associated with each processor thread T1, T2, . . . Tn. In one implementation, register file 110 includes separate banks (e.g., banks T1, T2, . . . Tn) that store data associated with a corresponding processor thread T1, T2, . . . Tn. For example, if write logic 116 is writing data associated with processor thread T2 back to register file 110, then write logic 116 writes the data to bank T2 of register file 110. Alternatively, a separate register file (not shown) for storing data corresponding to each processor thread T1, T2, . . . Tn can be implemented within multi-thread pipeline processor architecture 100.

Programmable thread allocation controller 118 can be programmed to store processor time allocations that have been defined for each processor thread T1, T2, . . . Tn—i.e., what portion of processor time will be dedicated to each processor thread T1, T2, . . . Tn. In one implementation, input, e.g., from a user, defining portions of processor time to be allocated to each of a plurality of processor threads (e.g., processor threads T1, T2, . . . Tn) is received through a graphical user interface (not shown). For example, a user can allocate 95% of processor time to a first processor thread and 5% to a second processor thread for a dual thread pipeline processor. In one implementation, the processor time allocation defined for each processor thread (e.g., processor threads T1, T2, . . . Tn) can be dynamically changed—i.e., changed during program execution—by a user or preferably by a software program (e.g., a software program to be executed). Alternatively, the processor time allocation for each processor thread can be statically set—i.e., not changeable during program execution.

In one implementation, programmable thread allocation controller 118 performs a context switch automatically by determining a processor thread from which a next instruction will be fetched (e.g., by instruction fetch unit 104). In one implementation, programmable thread allocation controller 118 performs a context switch by switching one or more selectors, e.g., multiplexers and/or de-multiplexers (not shown) that are in communication with instruction fetch unit 104. One implementation of a processor including multiplexers and de-multiplexers that performs context switches is discussed below in association with FIGS. 3, 4, and 5. When a context switch occurs, an instruction associated with a next processor thread is fetched by instruction fetch unit 104. Though the pipeline stages (e.g., pipeline stages IF, ID, IS, EX, MEM, WB) of multi-thread pipeline processor architecture 100 may contain instructions associated with two or more processor threads, data associated with each given processor thread is maintained separately through register file 110, thus, the integrity of data associated with each processor thread is maintained. Unlike a conventional pipeline processor that may require an interrupt service routine, programmable thread allocation controller 118 does not have any interrupt overhead associated with performing a context switch.

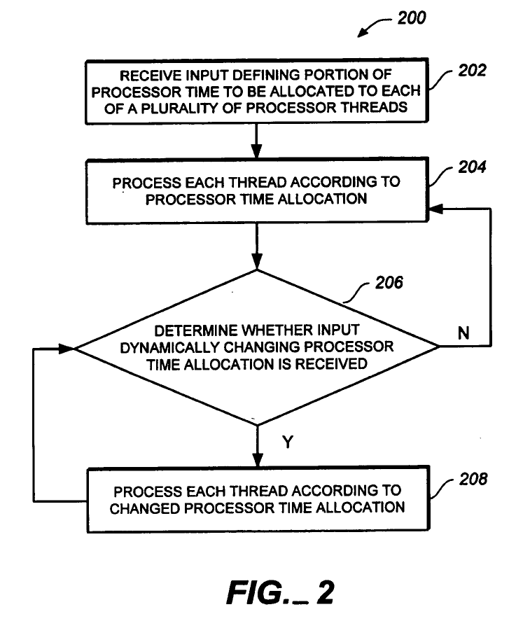

FIG. 2 shows a method 200 for processing processor threads through a multi-thread pipeline processor architecture (e.g., multi-thread pipeline processor architecture 100). Input defining a portion of processor time to be allocated to each of a plurality of processor threads is received (step 202). In one implementation, input allocations are received from a user through a graphical user interface. In one implementation, input allocations are determined based on requirements of an executing software application. The processor time allocated to each processor thread can be stored in a programmable thread allocation controller (e.g., programmable thread allocation controller 118). In one implementation, processor time is allocated based on CPU (Central Processing Unit) cycles, clock cycles and/or instruction cycles.

Each thread is processed by the multi-thread pipeline processor according to the processor time allocated to each thread (step 204). In one implementation, a context switch occurs automatically according to the processor time allocated to each thread as stored in the programmable thread allocation controller. In one implementation, a programmable thread allocation controller controls switching of one or more multiplexers and/or de-multiplexers that are in communication with an instruction fetch unit (e.g., instruction fetch unit 104). In one implementation, a programmable thread allocation controller controls switching of one or more multiplexers and/or de-multiplexers located before and after each pipeline stage of the multi-thread pipeline processor to perform a context switch, as discussed in greater detail below. In this implementation, a state of a processor thread is stored in, and loaded from, registers that are located before and after each pipeline stage in the pipeline processor. In one implementation, context switches occur at the end of a given instruction cycle.

A determination is made (e.g., through programmable thread allocation controller 118) whether input dynamically changing the processor time allocation is received (step 206). If the processor time allocated to each processor thread has not been dynamically changed, then each processor thread is processed according to the processor time allocation as previously established, and method 200 returns to step 204. If the processor time allocation has been dynamically changed, then each processor thread is processed according to the changed processor time allocation (step 208). After step 208, method 200 returns to step 206, discussed above.

FIG. 3 illustrates a block diagram of a multi-thread pipeline processor 300 built in accordance with multi-thread pipeline processor architecture 100 that processes (n) processor threads T1, T2, . . . Tn. In one implementation, multi-thread pipeline processor 300 includes an instruction fetch unit 304, a decoder 306, a register file 308, issue unit 310, a two-stage execution unit 312, a re-order buffer 314, and a programmable thread allocation controller 316. Multi-thread pipeline processor 300 further includes registers T1-Tn and program counters T1-Tn that respectively correspond to processor threads T1, T2, . . . Tn. Multi-thread pipeline processor 300 further includes multiplexer 350.

In one implementation, during an instruction fetch (IF) stage, instruction fetch unit 304 retrieves an instruction to be executed from, for example, instruction cache 302. Instruction fetch unit 304 retrieves instructions in accordance with program counters T1, T2, . . . Tn. In one implementation, program counter T1 indicates an execution status of processor thread T1 (i.e., where multi-thread pipeline processor 300 is with respect to an instruction sequence associated with processor thread T1), program counter T2 indicates an execution status associated with processor thread T2, and program counter Tn indicates an execution status associated with processor thread Tn.

During an instruction decode stage (ID), instructions retrieved by instruction fetch unit 304 are decoded.

During an instruction issue stage (IS), in one implementation, the decoded instructions are sent to re-order buffer 314 (through issue unit 310). Re-order buffer 314 stores the decoded instructions until the decoded instructions are issued for execution. In one implementation, re-order buffer 314 is a circular buffer.

Re-order buffer 314 also stores the results of executed instructions until the executed instructions are ready for retirement, e.g., into register file 308. In one implementation, register file 308 includes banks (e.g., banks T1, T2, . . . Tn) that correspond to each processor thread (e.g., processor threads T1, T2, . . . Tn) processed by multi-thread pipeline processor 300. Bank T1 holds data associated with processor thread T1, bank T2 holds data associated with processor thread T2, and bank Tn holds data associated with processor thread Tn. The data can include operands and/or results of executed instructions associated with a given processor thread. In one implementation, multi-thread pipeline processor 300 does not include a re-order buffer.

During executions stages EX1, EX2, execution unit 312 executes the decoded instructions issued from issue unit 310. Execution unit 312 can be any type of execution unit, as discussed above. Though execution unit 312 is shown as having two pipeline stages, execution unit 312 can have a different number of pipeline stages. In one implementation, results of the executed instructions are written back to re-order buffer 314, and then retired to register file 308.

Programmable thread allocation controller 316 is operable to be programmed to store processor time allocation for each processor thread T1, T2, . . . Tn—i.e., how much processor time will be dedicated to each processor thread T1, T2, . . . Tn. In one implementation, input, e.g., from a user, allocating portions of processor time to each processor thread T1, T2, . . . Tn is received through a graphical user interface (not shown). In one implementation, the processor time allocation for each processor thread T1, T2, . . . Tn can be dynamically changed by a user. In one implementation, the processor time allocation for each processor thread T1, T2, . . . Tn is changed dynamically through a software application being processed by multi-thread pipeline processor 300.

In one implementation, programmable thread allocation controller 316 automatically performs a context switch between processor threads T1, T2, . . . Tn by switching multiplexer 350 that is in communication with instruction fetch unit 304. For example, during a time that multi-thread pipeline processor 300 is processing processor thread T1, multiplexer 350 is controlled to pass instructions associated with processor thread T1 through the pipeline stages of multi-thread pipeline processor 300. When a context switch occurs from processor thread T1, multiplexer 350 is controlled to pass instructions associated with another processor thread, e.g., processor thread T2. In one implementation, multiplexer 350 is an n-to-1 multiplexer.

In one implementation, programmable thread allocation controller 316 includes a plurality of thread allocation counters (e.g., thread allocation counters T1-Tn) that determine a weighting that corresponds to processor time allocated to each processor thread. For example, in one implementation, each of thread allocation counters T1-Tn contains a value that represents how many CPU cycles are allocated for each thread. For example, if thread allocation counter T1 contains a value of 256, thread allocation counter T2 contains a value of 16, and thread allocation counter Tn contains a zero value, then instructions will be first fetched from processor thread T1 for 256 CPU cycles, then instructions will be fetched from processor thread T2 for 16 CPU cycles, and zero instructions will be fetched from processor thread Tn. Instructions are then fetched from processor threads T1 and T2 again for another 256 CPU cycles and 16 CPU cycles, respectively, and so on. The instruction fetching can continue accordingly until the values within one or more of the thread allocation counters are changed. As each thread allocation counter T1-Tn reaches a zero value, then programmable thread allocation counter 316 switches multiplexer 350 to pass instructions associated with a next processor thread to instruction fetch unit 304 for processing.

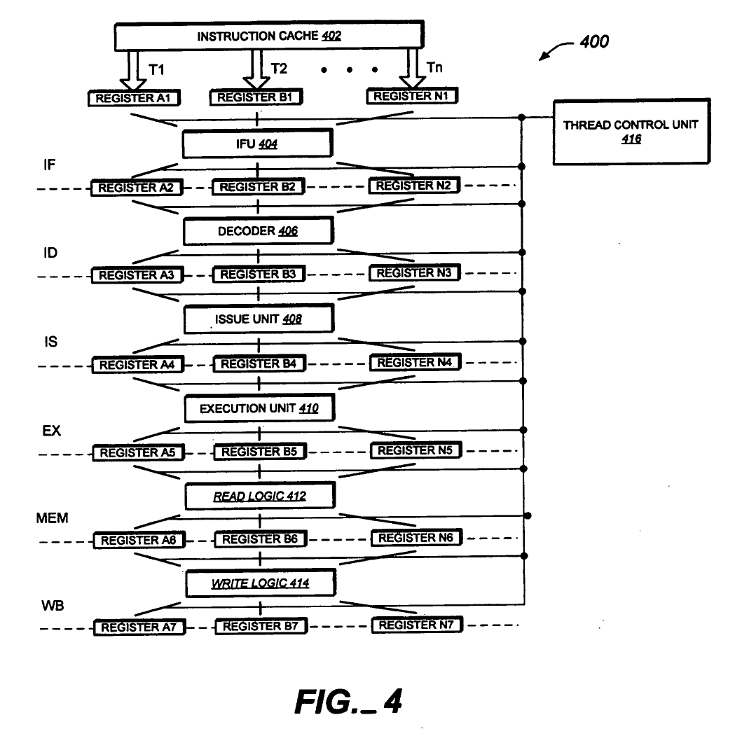

FIG. 4 is a block diagram of a multi-thread pipeline processor architecture 400 that is operable to process two or more processor threads T1, T2, . . . Tn. Instructions associated with processor threads T1, T2, . . . Tn can be retrieved from, for example, an instruction cache (e.g., instruction cache 402).

In one implementation, multi-thread pipeline processor architecture 400 includes six pipeline stages. The six pipeline stages include an instruction fetch stage (IF), an instruction decode stage (ID), an instruction issue stage (IS), an instruction execution stage (EX), a data memory read stage (MEM), and write back stage (WB). Multi-thread pipeline processor architecture 400, however, can include a different number of pipeline stages. Multi-thread pipeline processor architecture 400 further includes an instruction fetch unit (IFU) 404, decoder 406, issue unit 408, an execution unit 410, read logic 412, write logic 414, and a programmable thread allocation controller 416. Multi-thread pipeline processor architecture 400 is similar to multi-thread pipeline processor architecture of FIG. 1, however, multi-thread pipeline processor architecture 400 further includes a set registers (e.g., registers A1-A7, B1-B7, N1-N7) located between each pipeline stage (one before and after each stage) for storing a state of a corresponding processor thread T1, T2, . . . Tn during a context switch.

Registers A1-A7 store a state of processor thread T1. In a like manner, registers B1-B7 store a state of processor thread T2, and registers N1-N7 store a state of processor thread Tn. In one implementation, each register A1-A7, B1-B7, N1-N7 stores a state of a corresponding processor thread including storing a state of data produced by a corresponding pipeline stage of multi-thread pipeline processor architecture 400 at the end of given instruction cycle. For example, when processing instructions associated with processor thread T1, at the end of an instruction cycle register A3 can store a state of data for processor thread T1 received from decoder 406, and register A5 can store a state of data received from execution unit 410. Registers A1-A7, B1-B7, N1-N7 facilitate context switches in that they permit a state of a corresponding processor thread to be directly loaded from (or stored to) a given register. In one implementation, each set of registers A1-A7, B1-B7, N1-N7 is located relatively close to a functional unit within multi-thread pipeline processor architecture 400 (e.g., between each pipeline stage) and permits fast context switching times.

In one implementation, programmable thread allocation controller 416 performs a context switch automatically by switching one or more multiplexers and/or de-multiplexers (not shown) located before or after each pipeline stage (e.g., pipeline stages IF, ID, IS, EX, MEM, WB). One implementation of a processor including multiplexers and de-multiplexers that performs context switches is discussed below in association with FIG. 5. When a context switch occurs, one set of registers (e.g., registers A1-A7) associated with a current processor thread (e.g., processor thread T1) from which the context switch is to occur stores a state of the current processor thread. To complete the context switch, a state of a next processor thread (e.g., processor thread T2) is loaded from a different set of registers (e.g., registers B1-B7) associated with the next processor thread. The pipeline processor processes the next processor thread in the following instruction cycle. In one implementation, context switches occur at the end of an instruction cycle (i.e., after data from a pipeline stage has been saved to an associated register) to permit seamless context switches.

FIG. 5 illustrates a block diagram of a multi-thread pipeline processor 500 built in accordance with multi-thread pipeline processor architecture 400 that processes two threads T1, T2. In one implementation, multi-thread pipeline processor 500 includes an instruction fetch unit 504, a decoder 506, a register file 508, issue unit 510, a two-stage execution unit 512, a re-order buffer 514, and a programmable thread allocation controller 516. Multi-thread pipeline processor 500 further includes a first set of registers A1-A6 that corresponds to processor thread T1, and a second set of registers B1-B6 that corresponds to processor thread T2. Multi-thread pipeline processor 500 further includes program counters T1, T2, multiplexers 550, and de-multiplexers 552.

In one implementation, during an instruction fetch (IF) stage, instruction fetch unit 504 retrieves an instruction to be executed from, for example, instruction cache 502. Instruction fetch unit 504 retrieves instructions in accordance with program counters T1, T2. In one implementation, program counter T1 indicates an execution status of processor thread T1 (i.e., where multi-thread pipeline processor 500 is with respect to an instruction sequence associated with processor thread T1), and program counter T2 indicates an execution status associated with processor thread T2.

During an instruction decode stage (ID), instructions retrieved by instruction fetch unit 504 are decoded.

During an instruction issue stage (IS), in one implementation, the decoded instructions are sent to re-order buffer 514 (through issue unit 510). Re-order buffer 514 stores the decoded instructions until the decoded instructions are issued for execution. In one implementation, re-order buffer 514 is a circular buffer.

Re-order buffer 514 also stores the results of executed instructions until the executed instructions are ready for retirement, e.g., into register file 508. In one implementation, register file 508 includes two banks T1, T2. Bank T1 holds data associated with processor thread T1, and bank T2 holds data associated with processor thread T2. Register file 508 can include a thread index (not shown) that indicates registers from which data will be loaded. The thread index ensures that data from a register associated with a currently executing processor thread will be loaded into register file 508.

During executions stages EX1, EX2, execution unit 512 executes the decoded instructions issued from issue unit 510. Execution unit 512 can be any type of execution unit, as discussed above. Though execution unit 512 is shown as having two pipeline stages, execution unit 512 can have a different number of pipeline stages. In one implementation, results of the executed instructions are written back to re-order buffer 514, and then retired to register file 508.

Programmable thread allocation controller 516 is operable to be programmed to store processor time allocation for each processor thread T1, T2. In one implementation, programmable thread allocation controller 516 automatically performs a context switch between processor threads T1, T2 by switching multiplexers 550 and de-multiplexers 552 located respectively before and after each pipeline stage (e.g., pipeline stages IF, ID, IS, EX1, EX2) of multi-thread pipeline processor 500. For example, during a time that multi-thread pipeline processor 500 is processing processor thread T1, multiplexers 550 and de-multiplexers 552 are controlled to pass instructions associated with processor thread T1 (through the pipeline stages of multi-thread pipeline processor 500). State information for processor thread T2 is stored in registers B1-B6. When a context switch occurs from processor thread T1, registers A1-A6 store a state of processor thread T1, and a state of processor thread T2 is loaded from registers B1-B6 (through multiplexers 550 and de-multiplexers 552) and processed by multi-thread pipeline processor 500. In one implementation, each of multiplexers 550 is a 2-to-1 multiplexer, and each of de-multiplexers 552 is a 1-to-2 de-multiplexer.

Exception Handling

When a multi-thread pipeline processor (e.g., multi-thread pipeline processors 300, 500) built in accordance with multi-thread pipeline processor architectures 100, 400 detects an exception, the normal sequence of instruction execution is suspended. An exception is an event that causes suspension of normal program execution. Types of exceptions include, for example, addressing exceptions, data exceptions, operation exceptions, overflow exceptions, protection exceptions, underflow exceptions, and so on. An exception may be generated by hardware or software.

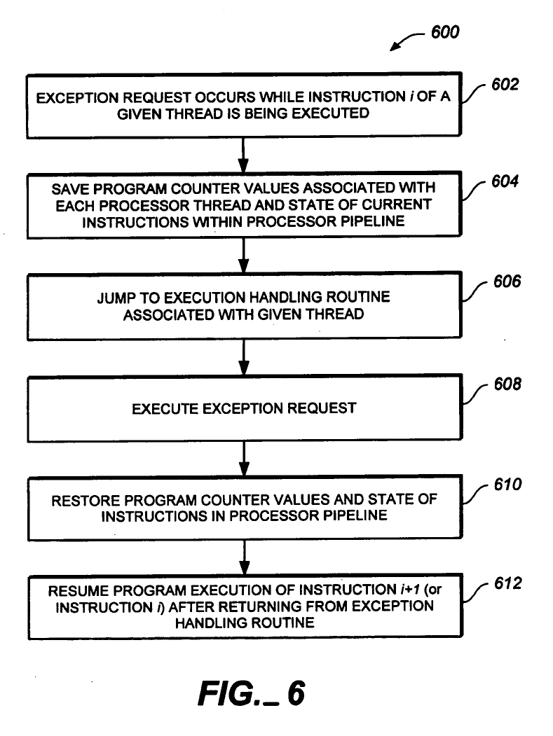

FIG. 6 illustrates a method for performing exception handling in a multi-thread pipeline processor implemented according to multi-thread pipeline processor architectures 100, 400. An exception request occurs while instruction i of a given thread is being executed (step 602). Program counter values associated with each processor thread are saved, along with a state of current instructions within the pipeline of the multi-thread processor (step 604). In one implementation, all instructions within the pipeline of the multi-thread processor are aborted, or flushed. The multi-thread processor jumps to an exception handling routine associated with a given thread (step 606). In one implementation, each processor thread has an associated exception handling routine that is separate and independent from exception handling routines associated with other processor threads. In one implementation, a single exception handling routine performs exception requests for all processor threads.

The exception request is executed by a given exception handling routine (step 608). After the exception request has been performed by the multi-thread processor, program counter values are restored within program counters of the processor, and a state of instructions (prior to the exception request) is restored within the pipeline of the multi-thread processor (step 610). The multi-thread processor resumes program execution of the next instruction (e.g., instruction i+1) after returning from an exception handling routine (step 612). In step 612, the multi-thread processor can resume program instruction at instruction i if the instruction is to be re-executed.

Interrupt Handling

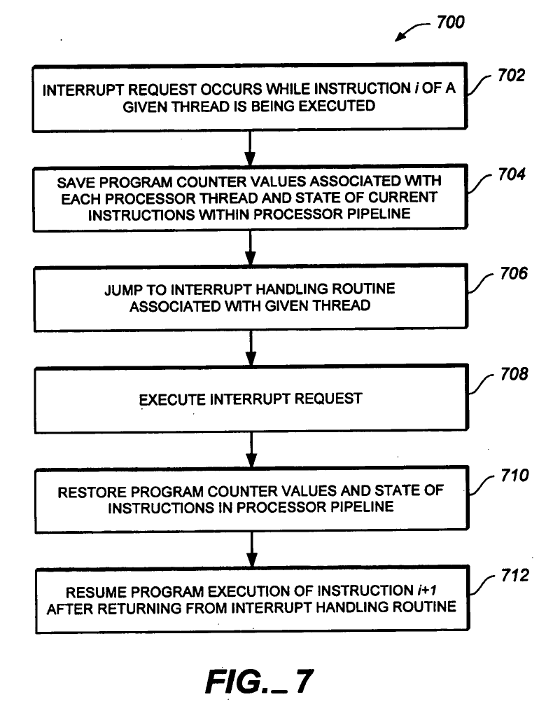

Interrupts within a multi-thread pipeline processor implemented according to multi-thread pipeline processor architectures 100, 400 are handled similarly to exceptions. FIG. 7 illustrates a method for handling interrupts in a multi-thread pipeline processor implemented according to multi-thread pipeline processor architectures 100, 400.

An interrupt occurs while instruction i of a given thread is being executed (step 702). Program counter values associated with each processor thread are saved, along with a state of current instructions within the pipeline of the multi-thread processor (step 704). The multi-thread processor jumps to an interrupt handling routine associated with a given thread (step 706). In one implementation, each processor thread has an associated interrupt handling routine having an entry point that is separate and independent from entry points associated with interrupt handling routines associated with other processor threads. An entry point is a starting address of an interrupt handling routine. In one implementation, a single interrupt handling routine (with a single entry point) performs interrupts for all processor threads.

The interrupt is executed by a given interrupt handling routine (step 708). After the interrupt has been performed by the multi-thread processor, program counter values are restored within program counters of the multi-thread processor, and a state of instructions (prior to the interrupt request) is restored within the pipeline of the multi-thread processor (step 710). The multi-thread processor resumes program execution of the next instruction (e.g., instruction i+1) after returning from an interrupt handling routine (step 712).

Applications

A multi-thread pipeline processor built in accordance with pipeline processor architectures 100, 400 can be used in a wide range of applications, including more specifically real-time control applications. Example applications include data storage applications, wireless applications, computer system applications, cellular WLAN applications, voice-over-internet protocol (VoIP) applications, wireless and wired network device applications, wireless television applications, broadband modem applications, wired router applications, wireless media applications, real-time controller applications, and other applications as described in greater detail below. It will be appreciated by one of ordinary skill in the art that other multi-thread processor architectures may be used by the aforementioned applications. Independent software program threads can be developed without impacting other processor threads. Moreover, each processor thread can be guaranteed computing resources in accordance with processing allocations enforced by the multi-thread processor.

Hard Disk Drive System

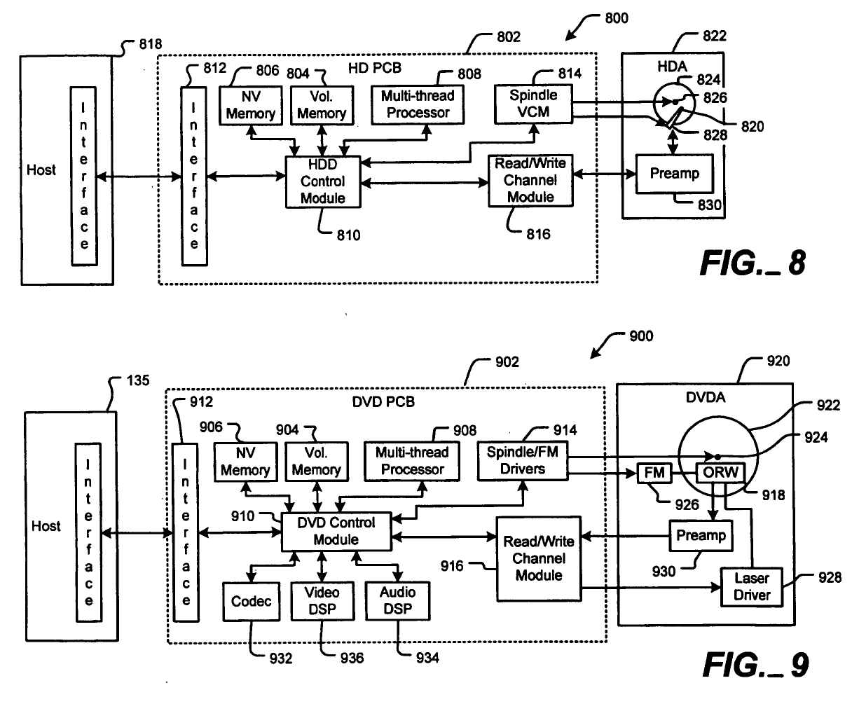

As shown in FIG. 8, a multi-thread processor 808 (e.g., multi-thread processors 300, 500, as discussed above) can be used within a hard disk drive system 800 to perform substantially all the processing functions associated with hard disk drive system 800.

Hard disk drive system 800 includes a printed circuit board 802. A volatile memory 804 stores read, write and/or volatile control data that is associated the control of the hard disk drive system 800. Volatile memory 804 can be a memory having low latency. For example, SDRAM or other types of low latency memory may be used. Nonvolatile memory 806 such as flash memory may also be provided to store critical data such as nonvolatile control code. The control code can include system level program code, including disk drive data capture program code, error correction program code, host protocol management program code, cache management program code, and defect manager program code. The host protocol management code can include program code that manages one or more of the following protocols Advanced Technology Attachment (ATA), Serial ATA (SATA), Consumer Electronics ATA (CE-ATA), Universal Serial Bus (USB), Serial Attached Small Computer System Interface (SAS), (Fibre Channel) FC, or Secure Digital Input/Output (SDIO). Volatile memory 804, nonvolatile memory 806, or other memory (e.g., cache memory) (not shown) can also store servo related program code—e.g., program code to operate a spindle/VCM driver 814 as discussed in greater detail below. Volatile memory 804, nonvolatile memory 806, or other memory can further store user provided program code—e.g., program code supplied by third parties. The user provided code can also be executed by multi-thread processor 808.

Multi-thread processor 808 performs data and/or control processing that is related to the operation of hard disk drive system 800. In one implementation, multi-thread processor 808 executes multiple processor threads that are each dedicated to a given processor function. For example, multiple processor threads executed by multi-thread processor 808 support the operation of hard disk control module (HDC) 810. Hard disk control module 810 communicates with an input/output interface 812, a spindle/voice coil motor (VCM) driver 814, and a read/write channel module 816. Through one or more processor threads executed by multi-thread processor 808, hard disk control module 810 coordinates control of the spindle/VCM driver 814, the read/write channel module 816 and data input/output with a host 818 through an interface 812.

As discussed above, multi-thread processor 808 can execute one or more processor threads that are dedicated to processing functions associated with read/write channel module 816. For example, during write operations, the read/write channel module 816 (through one or more processor threads executed by multi-thread processor 808) can encode data to be written onto by read/write device 820. Using multi-thread processor 808, read/write channel module 816 can also process a write signal for reliability and may apply, for example, error correction coding (ECC), run length limited coding (RLL), and so on, to data. Likewise, during read operations, read/write channel module 816 (using one or more processor threads executed by multi-thread processor 808) can convert an analog read signal output of read/write device 820 to a digital read signal. The converted signal can then be detected and decoded by conventional techniques to recover the data that was read by read/write device 820 using one or more processor threads executed by multi-thread processor 808.

Multi-thread processor 808 can also execute one or more processor threads that are dedicated to processing functions associated with a hard disk drive assembly (HDDA) 822. Hard disk drive assembly 822 includes one or more hard drive platters 824 that include magnetic coatings that store magnetic fields. The platters 824 are rotated by a spindle motor that is schematically shown at 826. Generally the spindle motor 826 rotates the hard drive platter 824 at a controlled speed during the read/write operations. One or more read/write arms 828 move relative to the platters 824 to read and/or write data to/from the hard drive platters 824. The spindle/VCM driver 814 controls the spindle motor 826, which rotates the platter 824. The spindle/VCM driver 814 also generates control signals that position the read/write arm 828, for example using a voice coil actuator, a stepper motor or any other suitable actuator. One or more processor threads executed by multi-thread processor 808 can be used to generate the control signals.

The read/write device 820 is located near a distal end of the read/write arm 828. The read/write device 820 includes a write element such as an inductor that generates a magnetic field. The read/write device 820 also includes a read element (such as a magneto-resistive (MR) element) that senses the magnetic field on the platter 824. Hard disk drive assembly 822 includes a preamp circuit 830 that amplifies the analog read/write signals. When reading data, the preamp circuit 830 amplifies low level signals from the read element and outputs the amplified signal to the read/write channel module 816. While writing data, a write current is generated that flows through the write element of the read/write device 820. The write current is switched to produce a magnetic field having a positive or negative polarity. The positive or negative polarity is stored by the hard drive platter 824 and is used to represent data.

Portions of hard disk drive system 800 may be implemented by a one or more integrated circuits (IC) or chips. For example, multi-thread processor 808 and hard disk control module 810 may be implemented by a single chip. Spindle/VCM driver 814 and/or read/write channel module 816 may also be implemented by the same chip as multi-thread processor 808, hard disk control module 810 and/or by additional chips. Alternately, most of hard disk drive system 800 other than hard disk drive assembly 822 may be implemented as a system on chip (SOC).

DVD System

Referring now to FIG. 9, a DVD system 900 is shown to include a DVD printed circuit board (PCB) 902, which includes a volatile memory 904 that stores read data, write data and/or volatile control code that is associated the control of the DVD system 900. Volatile memory 904 can include volatile memory such as SDRAM or other types of low latency memory. Nonvolatile memory 906, such as flash memory, can also be used for critical data such as data relating to DVD write formats and/or other nonvolatile control code. The control code can include control code as discussed above in connection with hard disk drive system 800 (FIG. 8). Volatile memory 904, nonvolatile memory 906, or other memory (e.g., cache memory) (not shown) can also store real-time program code that handles real-time data (e.g., real-time audio or video data).

A multi-thread processor 908 performs substantially all data and/or control processing that is related to the operation of the DVD system 900. In one implementation, multi-thread processor 908 performs all processing functions by executing multiple processor threads that are dedicated to corresponding processing functions discussed below. Multi-thread processor 908 can also perform decoding of copy protection and/or compression/decompression as needed.

A DVD control module 910 communicates with an input/output interface 912, a spindle/feed motor (FM) driver 914, and a read/write channel module 916. Through multi-thread processor 908, DVD control module 910 coordinates control of spindle/FM driver 914, a read/write channel module 916 and data input/output through an interface 912.

In one implementation, multi-thread processor 908 executes one or more processor threads that are dedicated to processing functions associated with read/write channel module 916. For example, during write operations, the read/write channel module 916 encodes the data to be written by an optical read/write (ORW) or optical read only (OR) device 918 to the DVD platter using program code executed by multi-thread processor 908. Using one or more processor threads executed by multi-thread processor 908, read/write channel module 916 processes the signals for reliability and may apply, for example, ECC, RLL, and the like. During read operations, the read/write channel module 916 converts an analog output of the ORW or OR device 918 to a digital signal. The converted signal is then detected and decoded by conventional techniques to recover the data that was written on the DVD (e.g., using program code executed by multi-thread processor 908).

Multi-thread processor 908 can also execute one or more processor threads that are dedicated to substantially all processing functions associated with a DVD assembly (DVDA) 920 discussed below. In one implementation, DVD assembly 920 includes a DVD platter 922 that stores data optically. The platter 922 is rotated by a spindle motor that is schematically shown at 924. The spindle motor 924 rotates the DVD platter 922 at a controlled and/or variable speed during the read/write operations. ORW or OR device 918 moves relative to the DVD platter 922 to read and/or write data from/to the DVD platter 922. ORW or OR device 918 typically includes a laser and an optical sensor.

During read operations for DVD read/write and DVD read only systems, the laser is directed at tracks on the DVD that contain lands and pits. The optical sensor senses reflections caused by the lands/pits. For DVD write applications, a laser may also be used to heat a die layer on DVD platter 922. In one implementation, if the die is heated to a first pre-determined temperature, the die becomes transparent and such can be used to represent a first binary digital value. If the die is heated to a second pre-determined temperature, the die becomes opaque and such can be used to represent a second binary digital value.

Multi-thread processor 908 can also execute one or more processor threads that are dedicated to substantially all the processing functions associated with Spindle/FM driver 914 discussed below. Spindle/FM driver 914 controls the spindle motor 924, which controllably rotates DVD platter 922. Spindle/FM driver 914 also generates control signals that position the feed motor 926, for example using a voice coil actuator, a stepper motor or any other suitable actuator. A feed motor 926 typically moves the ORW or OR device 918 radially relative to the DVD platter 922. A laser driver 928 generates a laser drive signal based on an output of the read/write channel module 916. DVD assembly 920 includes a preamp circuit 930 that amplifies analog read signals. When reading data, the preamp circuit 930 amplifies low level signals from ORW or OR device 918 and outputs the amplified signal to read/write channel module device 916.

DVD system 900 further includes a codec module 932 that encodes and/or decodes video such as any of the MPEG formats. One or more processor threads executed by multi-thread processor 908 can be allocated to codec module 932 for encoding/decoding purposes. Audio and/or video digital signal processors and/or modules 934 and 936, respectively, perform audio and/or video signal processing, respectively. One or more processor threads executed by multi-thread processor 908 can also be allocated to audio and video digital signal processors 934, 936 for signal processing.

As with hard disk drive system 800, portions of the DVD system 900 may be implemented by one or more integrated circuits (IC) or chips. For example, multi-thread processor 908 and DVD control module 910 may be implemented by a single chip. Spindle/FM driver 914 and/or read/write channel module 916 may also be implemented by the same chip as multi-thread processor 908, DVD control module 910 and/or by additional chips. In one implementation, most of DVD system 900 other than DVD assembly 920 may also be implemented as a SOC.

Cellular WLAN System

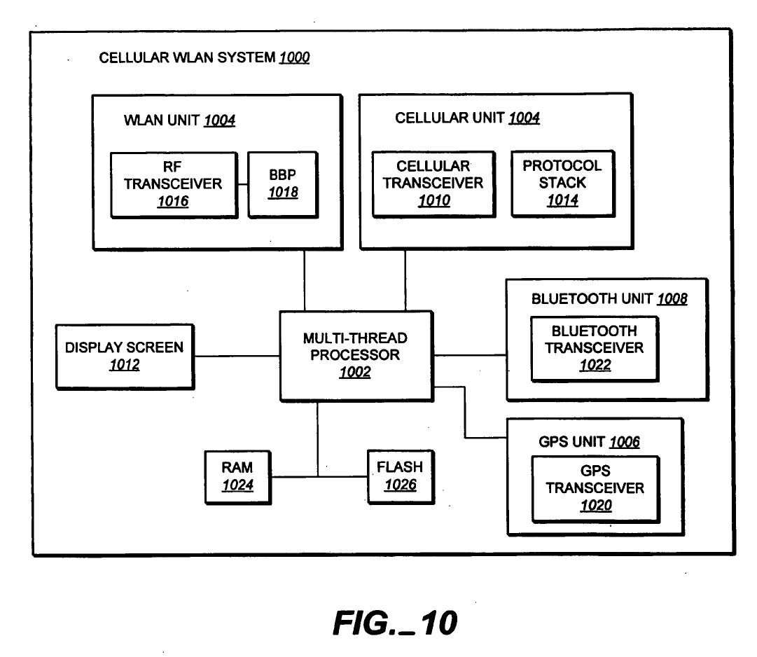

FIG. 10 illustrates a cellular wireless local area network (WLAN) system 1000 that includes a multi-thread processor 1002. In one implementation, multi-thread processor 1002 performs substantially all processing functions associated with cellular WLAN system 1000. Cellular WLAN system 1000 can be, for example, a cellular telephone with wireless fidelity (WI-FI) capability or a video phone. Cellular WLAN system 1000 can support one or more of the following multi-media features including a built-in digital camera or camcorder, a television (TV) tuner, a digital radio, and/or a walkie-talkie. In one implementation, multi-thread processor 1002 executes one or more processor threads that correspond to each of these multi-media features.

In one implementation, cellular WLAN system 1000 includes a WLAN unit 1004, a cellular unit 1006, a Bluetooth unit 1008, a global positioning system (GPS) unit 1010, and a display screen 1012. Optionally, cellular WLAN system 1000 may not include all these capabilities.

WLAN unit 1004 includes an RF transceiver 1014, a baseband processor (BBP) 1016, and a media access controller (MAC) (not shown). RF transceiver 1014 receives and transmits RF signals from/to other wireless devices and other network devices including, e.g., repeaters, routers, and so on. In one implementation, RF transceiver 1014 processes the RF signals from/to baseband in conformance with a radio frequency transmission protocol in use by the cellular WLAN system 1000. Baseband processor 1016 performs signal processing, including, for example, encoding/decoding and error correction. Multi-thread processor 1002 can execute one or more processor threads that perform signal processing functions associated with baseband processor 1016. The MAC includes one or more routines for processing received/and to be transmitted signals and interfacing with network components. The routines can be executed using multi-thread processor 1002.

Cellular unit 1006 includes a cellular transceiver 1018 and a protocol stack 1020. In one implementation, cellular transceiver 1018 includes a GSM RF transceiver. In one implementation, cellular transceiver 1018 processes the GSM RF signals from/to baseband in conformance with a GSM radio frequency transmission protocol in use by protocol stack 1020. Other protocols can be implemented by protocol stack 1020, including Code Division Multiple Access (CDMA), G3, and other cell phone protocol standards. Signal processing management, menu functions, and the like associated with cellular telephone functions can be realized by one or more processor threads executing in multi-thread processor 1002.

Optionally, cellular WLAN system 1000 includes a Bluetooth unit 1008. Bluetooth unit 1008 includes a Bluetooth transceiver 1022. In one implementation, Bluetooth transceiver 1022 is a short range wireless transceiver. In one implementation, a digital signal processor (not shown) processes the Bluetooth signals (executing one or more processor threads) in conformance with a Bluetooth protocol in use by cellular WLAN system 1000.

Optionally, cellular WLAN system 1000 includes a GPS unit 1010. GPS unit 1006 includes a GPS transceiver 1020. In one implementation, GPS transceiver 1020 processes GPS RF signals from/to baseband in conformance with a GPS radio frequency transmission protocol in use by cellular WLAN system 1000. Other processing functions required to support the Bluetooth protocol can be realized by processor threads executed by multi-thread processor 1002.

Optionally, cellular WLAN system 1000 includes a display screen 1012. Display screen 1012 provides a graphical user interface for a user. In one implementation, display screen 1012 is a liquid crystal display. In one implementation, display screen 1012 displays video data associated with a video phone. The graphical user interface can be provided by one or more cellular operating systems stored in random access memory 1024, flash memory 1026, or other memory (not shown). In one implementation, multi-thread processor 1002 processes the operating system and any other program code instructions executing one or more associated processor threads. The program code can include real-time program code. The program code can also include cellular communication related program code or system level program code. In one implementation, the cellular communication related program code relates to one or more of the following protocols CDMA, G3, GSM, or the like. In one implementation, the system level program code includes at least one of menu program code, display program code, MAC program code, WLAN program code, network communication program code, error correction program code, video processing program code, audio processing program code, host protocol management program code, cache management program code, defect manager program code, encryption/decryption program code, compression/decompression program code, wireless/wired communication program code or security management program code. The program code can also be stored in random access memory 1024, flash memory 1026, or other memory. Other program codes can be stored, for example, user provided code as discussed above.

VoIP System

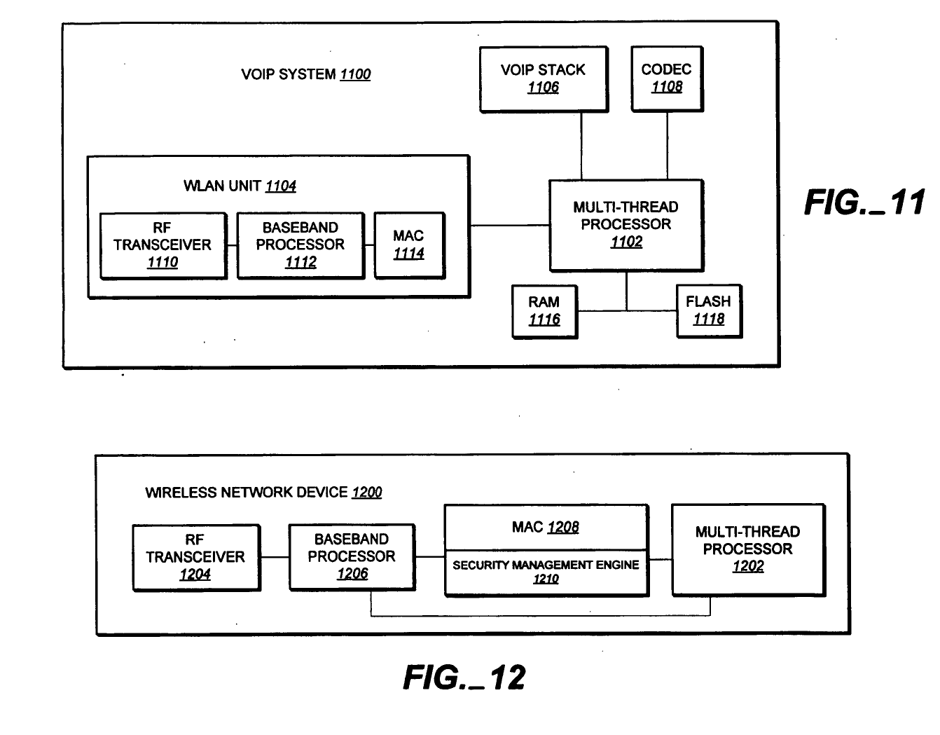

FIG. 11 illustrates a voice over internet protocol (VoIP) system 1100 that includes a multi-thread processor 1102. In one implementation, multi-thread processor 1102 performs substantially all the processing functions associated with VoIP system 1100. In one implementation, VoIP system 1100 includes a WLAN unit 1104, a VoIP stack 1106, and a codec 1108. Though VoIP system 1100 is shown as including a WLAN unit 1004, VoIP can include a LAN unit (not shown) for connection to a non-wireless local area network.

WLAN unit 1004 includes an RF transceiver 1110, a baseband processor 1112, and a media access controller (MAC) 1114. RF transceiver 1110 receives and transmits RF signals from/to other wireless devices and other network devices for transmission of voice data packets. In one implementation, RF transceiver 1110 processes the RF signals from/to baseband in conformance with a VoIP protocol in use by VoIP stack 1106. Baseband processor 1112 can perform signal processing, including, for example, encoding/decoding, compression/decompression, and error correction. Multi-thread processor 1102 can execute one or more processor threads to perform some or all of the processing functions associated with baseband processor 1112. MAC 1114 includes one or more processing routines (not shown) for processing received/and to be transmitted signals and interfacing with network components (using multi-thread processor 1102). In one implementation, codec 1108 converts digital signals to analog signals, and vice versa. The signal conversion can be processed using one or more processor threads executed by multi-thread processor 1102.

In one implementation, multi-thread processor 1102 processes program code instructions executing one or more associated processor threads. The program code can include real time program code. The program code can also include voice processing related program code and system level program code. In one implementation, the voice processing related program code is program code associated with processing voice signals for conversion to a suitable form for transmission over a network. In one implementation, the system level program code includes at least one of MAC program code, WLAN program code, network communication program code, error correction program code, video processing program code, audio processing program code, host protocol management program code, cache management program code, defect manager program code, encryption/decryption program code, compression/decompression program code, wireless/wired communication program code or security management program code. In one implementation, RAM memory 1116 and/or flash memory 1118 store real-time program code, user provided program code (discussed above), or other program code (discussed above) to be executed by VoIP system 1100.

Wireless Network Device

FIG. 12 illustrates a wireless network device 1200 that includes a multi-thread processor 1202. Wireless network device 1200 can be for example, a wireless router, wireless access point, and so on. In one implementation, multi-thread processor 1202 performs substantially all processing functions associated with wireless network device 1200. In one implementation, wireless network device 1200 includes a RF transceiver 1204, a baseband processor 1206, and a MAC 1208. Wireless network device 1200 can include an interface to a wired LAN connection through, e.g., a firewall or (Virtual Private Network) VPN. RF transceiver 1204 receives and transmits RF signals from/to network devices including, for example, wireless clients (not shown). RF transceiver 1204 processes the RF signals from/to baseband in conformance with a radio frequency transmission protocol in use by wireless network device 1200. Baseband processor 1206 can perform signal processing, including, for example, encoding/decoding, compression/decompression and error correction. Multi-thread processor 1202 can execute one or more processor threads to perform some or all of the processing functions associated with baseband processor 1206. MAC 1208 includes one or more processing routines for processing received/and to be transmitted signals and interfacing with the network components that can be executed by (i.e., processor thread executed by) multi-thread processor 1202.

Optionally, multi-thread processor 1202 can be used to execute other program code associated with wireless network device 1200. In one implementation, MAC 1208 includes a security management engine 1210 for initializing and updating configuration information with one or more wireless clients. Security management engine 1210 can be used to generate a service set identifier (SSID), secure key and personal identification numbers (PIN) as required. Security management engine 1210 can be of the form of hardware (circuits), software, firmware or combinations thereof. In one implementation, multi-thread processor 1202 provides substantially all processing functions associated with MAC 1208.

In one implementation, multi-thread processor 1202 processes program code instructions executing one or more associated processor threads. The program code can include real time program code. The program code can also include wireless network related program code and system level program code. In one implementation, the wireless network related program code includes at least one of routing program code, network program code, access point program code, repeater program code or program code implementing a wireless communication protocol. In one implementation, the system level code includes at least one of MAC program code, WLAN program code, network communication program code, error correction program code, video processing program code, audio processing program code, host protocol management program code, cache management program code, defect manager program code, encryption/decryption program code, compression/decompression program code, wired communication program code or security management program code. In one implementation, RAM memory 1116 and/or flash memory 1118 store real-time program code, user provided program code (discussed above), or other program code (discussed above) to be executed by multi-thread processor 1202 of wireless network device 1200.

Wireless Television System

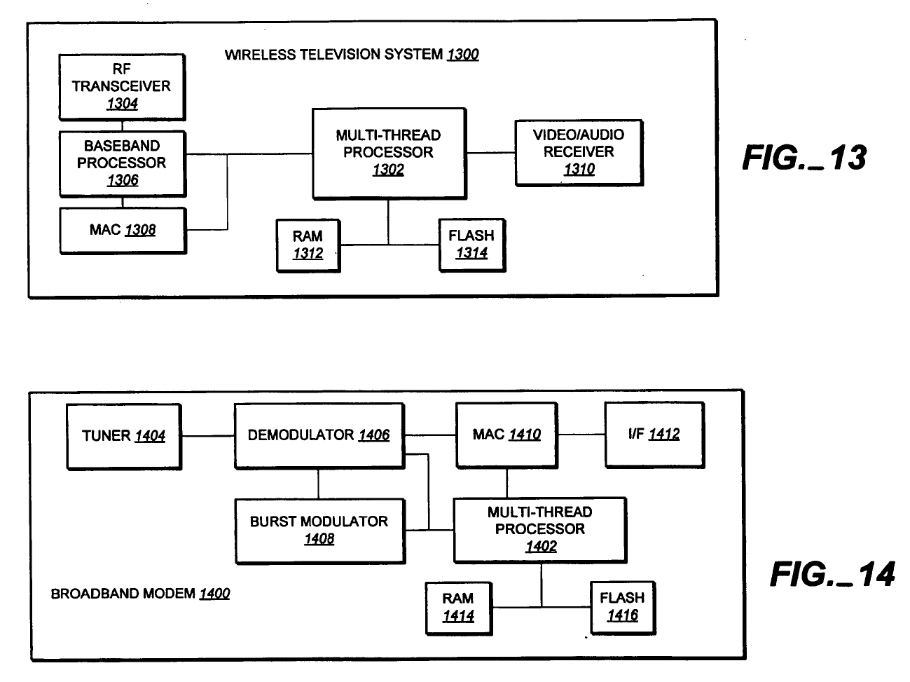

FIG. 13 illustrates a wireless television system 1300 that includes a multi-thread processor 1302. In one implementation, multi-thread processor 1302 performs substantially all the processing functions associated with wireless television system 1300. In one implementation, wireless television system 1300 includes a RF transceiver 1304, a baseband processor 1306, a MAC 1308, and a video/audio receiver 1310. RF transceiver 1304 receives and transmits RF signals from/to network devices including, for example, wireless router, access points, and so on. RF transceiver 1304 processes the RF signals from/to baseband in conformance with a radio frequency transmission protocol in use by wireless television system 1300. Baseband processor 1306 can perform signal processing, including, for example, encoding/decoding and error correction. Multi thread processor 1302 can execute one or more processor threads to perform some or all of the processing functions associated with baseband processor 1306. MAC 1308 includes one or more processing routines (executed by multi-thread processor 1302) for processing received/and to be transmitted signals and interfacing with the network components.

Video/audio receiver 1310 receives video and audio signals. The audio/video signals can be processed using one or more processor threads executed by multi-thread processor 1302. In one implementation, multi-thread processor 1302 also processes program code instructions executing one or more associated processor threads. The program code can include real time program code. The program code can also include media related program code and system level program code. In one implementation, the media related program code includes at least one of video processing program code, or audio processing program code. In one implementation, the system level program code includes at least one of MAC program code, WLAN program code, network communication program code, error correction program code, video processing program code, audio processing program code, host protocol management program code, cache management program code, defect manager program code, encryption/decryption program code, compression/decompression program code, wired/wireless communication program code or security management program code. In one implementation, RAM memory 1312, flash memory 1314, and/or other memory (not shown) store real-time program code or other program code for operating on, e.g., audio/video signals received through video/audio receiver 1310. Further examples of program codes include, for example, codecs.

Broadband Modem

FIG. 14 illustrates a broadband modem 1400 that includes a multi-thread processor 1402. In one implementation, broadband modem 1400 is a cable, digital subscriber link (DSL), satellite, or the like, modem. In one implementation, multi-thread processor 1402 performs substantially all the processing functions associated with broadband modem 1400. Broadband modem 1400 can be connected to, for example, a cable television line and provide to a connected device (e.g., a computer system) a continuous connection to the Internet. In one implementation, broadband modem 1400 includes a tuner 1404, a demodulator 1406, a burst modulator 1408, a MAC 1410, and an interface (I/F) 1412. Demodulator 1406 and burst modulator 1408 can be implemented within a single chip.

In one implementation, tuner 1404 connects directly to a source (e.g., a cable TV (CATV) outlet). Tuner 1404 can include a build-in diplexer (not shown) to provide both upstream and downstream signals through tuner 1404. In one implementation, tuner 1404 receives digitally modulated Quadrature Amplitude Modulation (QAM) signals.

In the receive direction, demodulator 1406 generates an intermediate frequency (IF) signal. Demodulator 1406 can perform analog-to-digital (A/D) conversion, QAM-demodulation, MPEG frame synchronization, and error correction (e.g., Reed Solomon error correction). In the transmit direction, burst modulator 1408 provides a signal to tuner 1404. In one implementation, burst modulator 1408 performs encoding of each burst, modulation of a Quadrature Phase Shift Keying (QSPK)/QAM signal on a selected frequency, and D/A conversion.

MAC 1410 includes one or more processing routines (not shown) executed by multi-thread processor 1402 for processing received/and to be transmitted signals and interfacing with network components. MAC 1410 can be implemented in hardware or software, or a combination of both. Data that passes through MAC 1410 enters interface 1412. Interface 1412 can be, for example, an Ethernet interface, USB interface, or PCI bus interface.

In one implementation, multi-thread processor 1402 processes program code instructions executing one or more associated processor threads. The program code can include real time program code. The program code can also include broadband communication related program code and system level program code. In one implementation, the broadband communication related program code includes a cable communication program code, DSL communication program code, or satellite communication program code. In one implementation, the system level code includes at least one of MAC program code, WLAN program code, network communication program code, error correction program code, video processing program code, audio processing program code, host protocol management program code, cache management program code, defect manager program code, encryption/decryption program code, compression/decompression program code, wired/wireless communication program code or security management program code. In one implementation, RAM memory 1414 and/or flash memory 1416 store real time program code, user provided program code (discussed above), or other program code (discussed above) to be executed by broadband modem 1400.

Wired Router

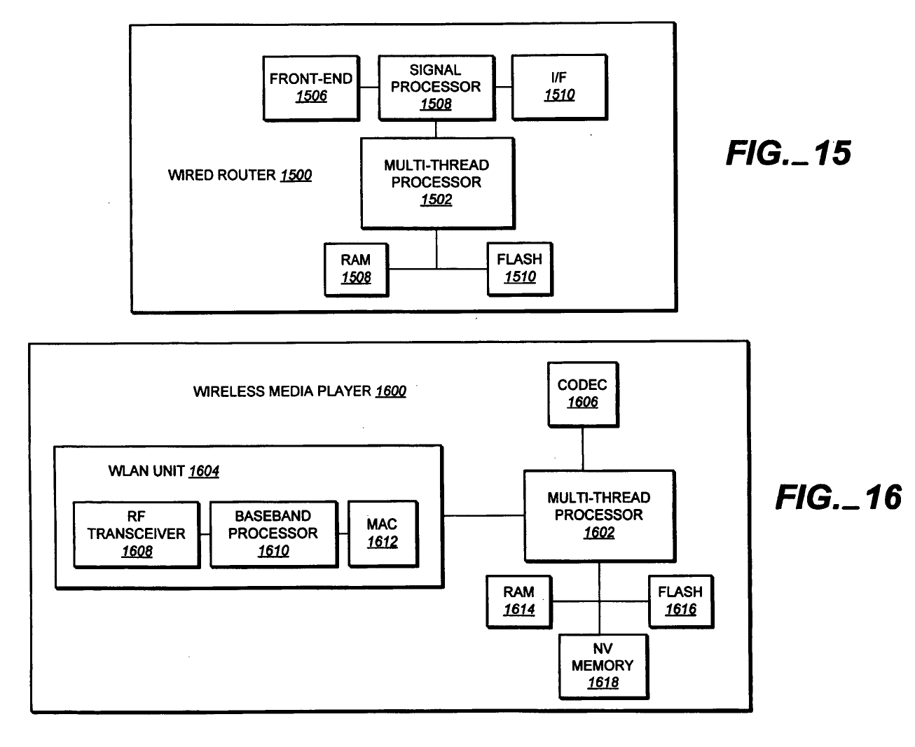

FIG. 15 illustrates a wired router 1500. In one implementation, wired router 1500 includes a multi-thread processor 1502, a front-end 1506, a signal processor 1508, and an interface (I/F) 1510. In one implementation, multi-thread processor 1502 performs substantially all the processing functions associated with wired router 1500.

In one implementation, front-end 1506 pre-amplifies, filters, and digitizes analog signals received from a phone line. Front-end 1506 can also amplify and filter analog signals created by a digital-to-analog converter (DAC) (not shown) and deliver analog signals at correct power levels. In one implementation, signal processor 1508 includes routines for performing signal processing including, for example, echo cancellation, error correction, digital coding, or rate adaptation that can be executed by multi-thread processor 1502. I/F 1510 allows wired router 1500 to be connected to high-speed devices.

In one implementation, multi-thread processor 1502 processes program code instructions executing one or more associated processor threads. The program code can include real time program code. The program code can also include networking related program code and system level program code. In one implementation, the networking related program code includes at least one of routing program code, access point program code, security program code, repeater program code or virtual private networking program code. In one implementation, the system level program code includes at least one of MAC program code, WLAN program code, network communication program code, error correction program code, video processing program code, audio processing program code, host protocol management program code, cache management program code, defect manager program code, encryption/decryption program code, compression/decompression program code, wireless communication program code or security management program code. In one implementation, RAM memory 1512 and/or flash memory 1514 store real time program code, user provided program code (discussed above), or other program code (discussed above) to be executed by wired router 1500.

Wireless Media Player

FIG. 16 illustrates a wireless media player 1600 that includes a multi-thread processor 1602. In one implementation, multi-thread processor 1602 performs substantially all the processing functions associated with wireless media player 1600. Wireless media player 1600 can be any type of wireless device that outputs visual and/or audio data. The audio data can include audio data associated with, e.g., MP3/MP4, Enhanced Perceptual Audio Coder (EPAC), QDesign Music playback, Advanced Audio Coding (AAC), Liquid Audio, Microsoft (MS) Audio, Dolby Digital, Real Audio (RA), Free Lossless Audio Codec (FLAC), or Windows Media Audio (WMA). Wireless media player 1600 can be an MP3/MP4 player, a personal digital assistant (PDA), and so on. In one implementation, wireless media player 1600 includes a WLAN unit 1604, and a codec 1606.

In one implementation, WLAN unit 1604 includes an RF transceiver 1608, a baseband processor 1610, and a MAC 1612. RF transceiver 1612 receives and transmits RF signals from/to other wireless devices and other network devices. RF transceiver 1608 processes the RF signals from/to baseband in conformance with a radio frequency transmission protocol in use by wireless media player 1600. Baseband processor 1610 can perform signal processing, including, for example, encoding/decoding and error correction. Multi-thread processor 1602 can execute one or more processor threads to perform some or all of the processing functions associated with baseband processor 1610. MAC 1612 includes one or more processing routines (not shown) executed by multi-thread processor 1602 for processing received/and to be transmitted signals and interfacing with network components. In one implementation, codec 1606 includes program code to encode and/or decode a signals received by RF transceiver 1608. The encoding and/or decoding program code can be processed using one or more processor threads executed by multi-thread processor 1602. In one implementation, codec 1606 includes program code to compress and decompress data. Codec 1606 can be implemented in software, hardware, or a combination of both. Examples of codecs for computer video include MPEG, Indeo and Cinepak 2.

In one implementation, multi-thread processor 1602 processes program code instructions executing one or more associated processor threads. The program code can include real time program code. The program code can also include media related program code and system level program code. In one implementation, the media related program code includes audio related program code and video related program code. In one implementation, the system level program code includes at least one of servo related program code, disk drive data capture program code, error correction program code, video processing program code, audio processing program code, cache management program code, defect manager program code, or encryption and security management program code. In one implementation, RAM memory 1614, flash memory 1616, nonvolatile memory 1618, and/or other memory (not shown) can store real-time program code, user provided program code and/or other program code (discussed above) to be executed by wireless media player 1600.

Real-Time Controller

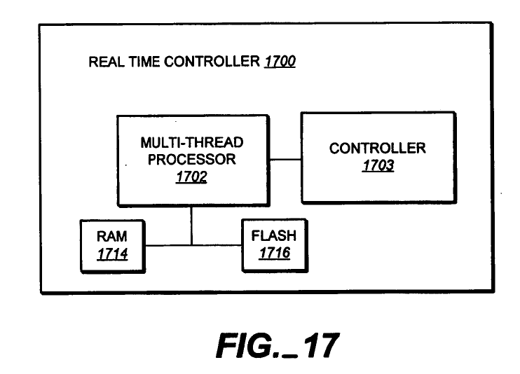

FIG. 17 illustrates a real-time controller 1700 that includes a multi-thread processor 1702 and a controller 1703. Real-time controller 1700 is operable to process real-time program code and control a controlled device (not shown). In one implementation, multi-thread processor 1702 performs substantially all the processing functions associated with real-time controller 1700. Real-time controller 1700 can be any type of wireless or wired device that processes real-time program code.

In one implementation, RAM memory 1714 and/or flash memory 1716 store real-time program code to be executed by real-time controller 1700. The real-time program code can be processed using one or more processor threads executed by multi-thread processor 1702.

A number of implementations have been described. Nevertheless, it will be understood that various modifications may be made. For example, though the applications described above include a single multi-thread processor, any of the applications can include two or more multi-thread processors. For example, hard disk drive system 800 can include two multi-thread processors (e.g., a first multi-thread processor and a second multi-thread processor). In one implementation, the second multi-thread processor executes a processor thread not executed by the first multi-thread processor. Also, the steps of the methods described above can be performed in a different order and still achieve desirable results. Accordingly, other implementations are within the scope of the following claims.

What is claimed is:

1. A hard disk controller comprising:
a multi-thread processor adapted to execute at least two threads of program code, the multi-thread processor including,
an execution pipeline, and
a thread control unit to control the execution pipeline to execute servo related program code as a first thread and system level program code as a second thread.

2. The hard disk controller of claim 1, further comprising a memory to store the servo related program code and the system level program code.

3. The hard disk controller of claim 2, wherein the memory further stores user provided program code, and wherein the thread control unit further controls the execution pipeline to execute the user provided program code as a third thread.

4. The hard disk controller of claim 1, wherein the execution pipeline comprises:
an instruction fetch unit;
a decoder responsive to the instruction fetch unit;
an issue unit responsive to the decoder; and
an execution unit responsive to the issue unit.

5. The hard disk controller of claim 1, wherein the system level program code comprises at least one of disk drive data capture program code, error correction program code, host protocol management program code, cache management program code, or defect manager program code.

6. The hard disk controller of claim 5, wherein the host protocol management program code manages at least one of the following protocols ATA, USB, SATA, SAS, FC, CE-ATA, or SDIO.

7. The hard disk controller of claim 1, further comprising:
a second multi-thread processor adapted to execute at least two threads of program code, the second multi-thread processor including,
a second execution pipeline, and
a second thread control unit to control the second execution pipeline to execute first real-time program code as a third thread and second real-time program code as a fourth thread.

8. The hard disk controller of claim 7, wherein the second multi-thread processor executes a given thread of program code not executed by the first multi-thread processor.

9. The hard disk controller of claim 1, further comprising a read channel.

10. A hard disk drive comprising:
a magnetic medium;
a read/write head to read from the magnetic medium and write to the magnetic medium; and
the hard disk controller of claim 9, wherein the hard disk controller is in communication with the read/write head.

11. A host computer comprising:
the hard disk drive of claim 10;
a memory; and
a processor in communication with the hard disk drive and the memory.

12. A DVD controller comprising:
a multi-thread processor adapted to execute at least two threads of program code, the multi-thread processor including,
an execution pipeline, and
a thread control unit to control the execution pipeline to execute servo related program code as a first thread and system level program code as a second thread.

13. The DVD controller of claim 12, further comprising a memory to store the servo related program code and the system level program code.

14. The DVD controller of claim 13, wherein the memory further stores user provided program code, and wherein the thread control unit further controls the execution pipeline to execute the user provided program code as a third thread.

15. The DVD controller of claim 13, wherein the system level program code includes audio processing program code, and wherein the thread control unit further controls the execution pipeline to execute the audio processing program code as a third thread.

16. The DVD controller of claim 12, wherein the execution pipeline comprises:
an instruction fetch unit;
a decoder responsive to the instruction fetch unit;
an issue unit responsive to the decoder; and
an execution unit responsive to the issue unit.

17. The DVD controller of claim 12, wherein the system level program code comprises at least one of DVD data capture program code, error correction program code, video processing program code, audio processing program code, host protocol management program code, cache management program code, defect manager program code, or encryption and security management program code.

18. The DVD controller of claim 17, wherein the host management program code manages at least one of the following protocols ATA, USB, SATA, SAS, FC, CE-ATA, or SDIO.

19. The DVD controller of claim 12, further comprising:
a second multi-thread processor adapted to execute at least two threads of program code, the second multi-thread processor including,
a second execution pipeline, and
a second thread control unit to control the second execution pipeline to execute first real-time program code as a third thread and second real-time program code as a fourth thread.

20. The DVD controller of claim 12, further comprising a read channel.

21. A DVD drive comprising:
a read device to read from an optical media; and
the DVD controller of claim 20, wherein the DVD controller is in communication with the read device.

22. A host computer comprising:
the DVD drive of claim 21;
a memory; and
a processor in communication with the DVD drive and the memory.

23. A DVD player comprising:
the DVD drive of claim 21;
a processor in communication with the DVD drive; and
an interface to communicate with a video output device.

24. A media player device comprising:
a multi-thread processor adapted to execute at least two threads of program code, the multi-thread processor including,
an execution pipeline, and
a thread control unit to control the execution pipeline to execute media processing related program code as a first thread and system level program code as a second thread.

25. The media player device of claim 24, wherein the media processing related program code comprises audio related program code.

26. The media player device of claim 24, wherein the media processing related program code comprises video related program code.

27. The media player device of claim 24, further comprising a memory storing the media processing related program code and the system level program code.

28. The media player device of claim 27, wherein the memory further stores user provided program code, and wherein the thread control unit further controls the execution pipeline to execute the user provided program code as a third thread.

29. The media player device of claim 24, wherein the execution pipeline comprises:
an instruction fetch unit;
a decoder responsive to the instruction fetch unit;
an issue unit responsive to the decoder; and
an execution unit responsive to the issue unit.

30. The media player device of claim 24, wherein the system level program code comprises at least one of servo related program code, disk drive data capture program code, error correction program code, video processing program code, audio processing program code, cache management program code, defect manager program code, or encryption and security management program code.

31. The media player device of claim 24, further comprising:
a second multi-thread processor adapted to execute at least two threads of program code, the second multi-thread processor including,
a second execution pipeline, and
a second thread control unit to control the second execution pipeline to execute first real-time program code as a third thread and second real-time program code as a fourth thread.

32. The media player device of claim 24, further comprising:
a storage medium to store at least one of audio or video data thereon; and
an output device to output the at least one of the audio or video data.

33. The media player device of claim 32, wherein the audio data is selected from the group consisting of MP3, EPAC™, QDesign Music playback, AAC, Liquid Audio, MS Audio, Dolby Digital, RA, FLAC or WMA.

34. A cellular WLAN system comprising:
a multi-thread processor adapted to execute at least two threads of program code, the multi-thread processor including,
an execution pipeline, and
a thread control unit to control the execution pipeline to execute cellular communication related program code as a first thread and system level program code as a second thread.

35. The cellular WLAN system of claim 34, wherein the cellular communication related program code relates to one or more of the following protocols CDMA, G3, or GSM.

36. The cellular WLAN system of claim 34, further comprising a memory to store the cellular communication related program code and the system level program code.

37. The cellular WLAN system of claim 36, wherein the memory further stores user provided program code, and wherein the thread control unit further controls the execution pipeline to execute the user provided program code as a third thread.

38. The cellular WLAN system of claim 34, wherein the execution pipeline comprises:
an instruction fetch unit;
a decoder responsive to the instruction fetch unit;
an issue unit responsive to the decoder; and
an execution unit responsive to the issue unit.

39. The cellular WLAN system of claim 34, wherein the system level program code includes at least one of menu program code, display program code, MAC program code, WLAN program code, network communication program code, error correction program code, video processing program code, audio processing program code, host protocol management program code, cache management program code, defect manager program code, encryption/decryption program code, compression/decompression program code, wireless/wired communication program code or security management program code.

40. The cellular WLAN system of claim 34, further comprising:
a second multi-thread processor adapted to execute at least two threads of program code, the second multi-thread processor including,
a second execution pipeline, and
a second thread control unit to control the second execution pipeline to execute first real-time program code as a third thread and second real-time program code as a fourth thread.

41. A VoIP system comprising:
a multi-thread processor adapted to execute at least two threads of program code, the multi-thread processor including,
an execution pipeline, and
a thread control unit to control the execution pipeline to execute voice processing related program code as a first thread and system level program code as a second thread.

42. The VoIP system of claim 41, further comprising a memory to store the voice processing related program code and the system level program code.

43. The VoIP system of claim 42, wherein the memory further stores user provided program code, and wherein the thread control unit further controls the execution pipeline to execute the user provided program code as a third thread.

44. The VoIP system of claim 41, wherein the thread control unit further controls the execution pipeline to execute codec related program code as a third thread.

45. The VoIP system of claim 41, wherein the voice processing related program code is program code associated with processing voice signals for conversion to a suitable form for transmission over a network.

46. The VoIP system of claim 41, wherein the execution pipeline comprises:
an instruction fetch unit;
a decoder responsive to the instruction fetch unit;
an issue unit responsive to the decoder; and
an execution unit responsive to the issue unit.

47. The VoIP system of claim 41, wherein the system level program code includes at least one of MAC program code, WLAN program code, network communication program code, error correction program code, video processing program code, audio processing program code, host protocol management program code, cache management program code, defect manager program code, encryption/decryption program code, compression/decompression program code, wireless/wired communication program code or security management program code.

48. The VoIP system of claim 41, further comprising:
a second multi-thread processor adapted to execute at least two threads of program code, the second multi-thread processor including,
a second execution pipeline, and
a second thread control unit to control the second execution pipeline to execute first real-time program code as a third thread and second real-time program code as a fourth thread.

49. A wireless network device comprising:
a multi-thread processor adapted to execute at least two threads of program code, the multi-thread processor including,
an execution pipeline, and
a thread control unit to control the execution pipeline to execute wireless networking related program code as a first thread and system level program code as a second thread.

50. The wireless network device of claim 49, wherein the system level program code includes at least one of MAC program code, WLAN program code, network communication program code, error correction program code, video processing program code, audio processing program code, host protocol management program code, cache management program code, defect manager program code, encryption/decryption program code, compression/decompression program code, wired communication program code or security management program code.

51. The wireless network device of claim 49, further comprising a memory to store the wireless networking related program code and the system level program code.

52. The wireless network device of claim 51, wherein the memory further stores user provided program code, and wherein the thread control unit further controls the execution pipeline to execute the user provided program code as a third thread.

53. The wireless network device of claim 49, wherein the execution pipeline comprises:
an instruction fetch unit;
a decoder responsive to the instruction fetch unit;
an issue unit responsive to the decoder; and
an execution unit responsive to the issue unit.

54. The wireless network device of claim 49, wherein the wireless networking related program code includes at least one of routing program code, network program code, access point program code, repeater program code, security program code, or program code implementing a wireless communication protocol.

55. The wireless network device of claim 49, further comprising:
a second multi-thread processor adapted to execute at least two threads of program code, the second multi-thread processor including,
a second execution pipeline, and
a second thread control unit to control the second execution pipeline to execute first real-time program code as a third thread and second real-time program code as a fourth thread.

56. The wireless network device of claim 49, wherein the wireless network device is one of a wireless router or a wireless access point.

57. A wireless television system comprising:
a multi-thread processor adapted to execute at least two threads of program code, the multi-thread processor including,
an execution pipeline, and
a thread control unit to control the execution pipeline to execute media related program code as a first thread and system level program code as a second thread.

58. The wireless television system of claim 57, wherein the media related program code includes at least one of video processing program code, or audio processing program code.

59. The wireless television system of claim 57, further comprising a memory to store the media related program code and the system level program code.

60. The wireless television system of claim 59, wherein the memory further stores user provided program code, and wherein the thread control unit further controls the execution pipeline to execute the user provided program code as a third thread.

61. The wireless television system of claim 57, wherein the execution pipeline comprises:
an instruction fetch unit;
a decoder responsive to the instruction fetch unit;
an issue unit responsive to the decoder; and
an execution unit responsive to the issue unit.

62. The wireless television system of claim 57, wherein the system level program code includes at least one of MAC program code, WLAN program code, network communication program code, error correction program code, video processing program code, audio processing program code, host protocol management program code, cache management program code, defect manager program code, encryption/decryption program code, compression/decompression program code, wired/wireless communication program code or security management program code.

63. The wireless television system of claim 57, further comprising:
a second multi-thread processor adapted to execute at least two threads of program code, the second multi-thread processor including,
a second execution pipeline, and
a second thread control unit to control the second execution pipeline to execute first real-time program code as a third thread and second real-time program code as a fourth thread.

64. A broadband modem comprising:
a multi-thread processor adapted to execute at least two threads of program code, the multi-thread processor including,
an execution pipeline, and
a thread control unit to control the execution pipeline to execute broadband communication related program code as a first thread and system level program code as a second thread.

65. The broadband modem of claim 64, wherein the system level program code includes at least one of MAC program code, WLAN program code, network communication program code, error correction program code, video processing program code, audio processing program code, host protocol management program code, cache management program code, defect manager program code, encryption/decryption program code, compression/decompression program code, wired/wireless communication program code or security management program code.

66. The broadband modem of claim 64, further comprising a memory to store the broadband communication related program code and the system level program code.

67. The broadband modem of claim 66, wherein the memory further stores user provided program code, and wherein the thread control unit further controls the execution pipeline to execute the user provided program code as a third thread.

68. The broadband modem of claim 64, wherein the execution pipeline comprises:
an instruction fetch unit;
a decoder responsive to the instruction fetch unit;
an issue unit responsive to the decoder; and
an execution unit responsive to the issue unit.

69. The broadband modem of claim 64, wherein the broadband communication related program code includes cable communication program code, DSL communication program code, or satellite communication program code.

70. The broadband modem of claim 64, further comprising:
a second multi-thread processor adapted to execute at least two threads of program code, the second multi-thread processor including,
a second execution pipeline, and
a second thread control unit to control the second execution pipeline to execute first real-time program code as a third thread and second real-time program code as a fourth thread.

71. A wired router comprising:
a multi-thread processor adapted to execute at least two threads of program code, the multi-thread processor including,
an execution pipeline, and
a thread control unit to control the execution pipeline to execute networking related program code as a first thread and system level program code as a second thread.

72. The wired router of claim 71, wherein the system level program code includes at least one of MAC program code, WLAN program code, network communication program code, error correction program code, video processing program code, audio processing program code, host protocol management program code, cache management program code, defect manager program code, encryption/decryption program code, compression/decompression program code, wireless communication program code or security management program code.

73. The wired router of claim 71, further comprising a memory to store the networking related program code and the system level program code.

74. The wired router of claim 73, wherein the memory further stores user provided program code, and wherein the thread control unit further controls the execution pipeline to execute the user provided program code as a third thread.

75. The wired router of claim 71, wherein the execution pipeline comprises:
an instruction fetch unit;
a decoder responsive to the instruction fetch unit;
an issue unit responsive to the decoder; and
an execution unit responsive to the issue unit.

76. The wired router of claim 71, wherein the networking related program code includes at least one of routing program code, access point program code, security program code, repeater program code or virtual private networking program code.

77. The wired router of claim 71, further comprising:
a second multi-thread processor adapted to execute at least two threads of program code, the second multi-thread processor including,
a second execution pipeline, and
a second thread control unit to control the second execution pipeline to execute first real-time program code as a third thread and second real-time program code as a fourth thread.

78. A real-time controller comprising:
a multi-thread processor adapted to execute at least two threads of program code, the multi-thread processor including,
an execution pipeline, and
a thread control unit to control the execution pipeline to execute first real-time program code as a first thread and second real-time program code as a second thread.

79. The real-time controller of claim 78, further comprising a memory to store the first real-time program code and the second real-time program code.

80. The real-time controller of claim 79, wherein the memory further stores user provided program code, and wherein the thread control unit further controls the execution pipeline to execute the user provided program code as a third thread.

81. The real-time controller of claim 78, wherein the execution pipeline comprises:
an instruction fetch unit;
a decoder responsive to the instruction fetch unit;
an issue unit responsive to the decoder; and
an execution unit responsive to the issue unit.

82. The real-time controller of claim 78, further comprising:
a second multi-thread processor adapted to execute at least two threads of program code, the second multi-thread processor including,
a second execution pipeline, and
a second thread control unit to control the second execution pipeline to execute third real-time program code as a third thread and fourth real-time program code as a fourth thread.

83. The real-time controller of claim 78, wherein the first real time code is video processing program code and the second real time code is audio program code.

84. A method comprising:
providing a first real-time program code;
providing a second real-time program code;
executing the first real-time program code with a first processor thread though an execution pipeline of a multi-thread processor; and
executing the second real-time program code with a second processor thread though the execution pipeline of the multi-thread processor.

85. The method of claim 84, further comprising storing the first real-time program code and the second real-time program code.

86. The method of claim 85, further comprising:
storing user provided program code; and
executing the user provided program code with a third processor thread though the execution pipeline of the multi-thread processor.
